(19) United States
(12) Patent Application Publication
(10) Pub. No.: US 2021/0302772 A1
(43) Pub. Date: Sep. 30, 2021

(54) HIGH RESOLUTION DISPLAY WITH INTEGRATED STRAIN GAUGE SENSOR FOR FORCE SENSING

(71) Applicant: SHARP KABUSHIKI KAISHA, Osaka (JP)

(72) Inventors: Jean de Dieu B. MUGIRANEZA, Osaka (JP); YASUHIRO SUGITA, Osaka (JP); KAZUTOSHI KIDA, Osaka (JP)

(21) Appl. No.: 16/829,584

(22) Filed: Mar. 25, 2020

(51) Int. Cl. G02F 1/1333; G02F 1/1335; G06F 3/041

(52) U.S. Cl. CPC G02F 1/13338; G02F 1/133512; G06F 3/0414; G06F 3/0412; G02F 1/133514

(57) ABSTRACT

A display device includes a touch detection layer for detecting one or more touch locations on the display device, a strain gauge sensor layer for sensing one or more touch forces applied to the display device, the strain gauge layer being separate from the touch detection layer. One or more patterned strain gauge traces are patterned in the strain gauge sensor layer. The one or more patterned strain gauge traces are formed between a plurality of pixels. At least one of the patterned strain gauge traces has a serpentine pattern.

### FIELD

The present disclosure generally relates to high resolution displays, and in particular to high resolution displays having integrated strain gauge sensors for force sensing.

### BACKGROUND

In recent years, attention has been drawn to pressure sensors that can detect a touch made on a display panel. The goal is to allow the display panel having the pressure sensor to distinguish between (i) a press touch which is made by relatively firmly pressing a screen of the display panel so as to press, for example, an OK button displayed on the screen and (ii) a feather touch which is made by a relatively soft and smooth touch on the screen. It is therefore expected that equipping a display panel with such a pressure sensor will improve an input error correction/prevention function of the display panel.

However, the foregoing pressure sensor is accessorily provided beneath a backlight unit of the display panel. For example, in a case where a display panel includes (i) a circuit board, (ii) a counter substrate, (iii) a liquid crystal layer provided between the circuit board and the counter substrate, and (iv) a backlight unit disposed on a side of the counter substrate opposite to the liquid crystal layer, the pressure sensor is externally disposed on a side of the backlight unit opposite to the counter substrate. This configuration imposes limitations on the freedom of display design, and results in a bulky display panel with extra thickness and a wide bezel around the display area.

Thus, there is a need in the art for a display panel having an integrated touch force sensor.

### CITATION LIST

JP Patent Application Publication No. 2017-182344A (Published on Oct. 5, 2017).

### SUMMARY

The present disclosure is directed to a high resolution display having an integrated strain gauge sensor for force sensing.

In an aspect of the present disclosure, a display device includes a touch detection layer for detecting one or more touch locations on the display device; a strain gauge sensor layer for sensing one or more touch forces applied to the display device, the strain gauge layer being separate from the touch detection layer; one or more patterned strain gauge traces in the strain gauge sensor layer; and a plurality of pixels; where the one or more patterned strain gauge traces are formed between the plurality of pixels; where at least one of the one or more patterned strain gauge traces has a serpentine pattern.

In an implementation of the aspect, the display device also includes a light shielding layer patterned between the plurality of pixels, where the one or more patterned strain gauge traces overlap with the light shielding layer.

In another implementation of the aspect, the display device also includes a liquid crystal layer between a color filter substrate and the touch detection layer, where the strain gauge sensor layer is disposed between the color filter substrate and the liquid crystal layer.

In yet another implementation of the aspect, the display device also includes a circuit board; a substrate disposed so as to face the circuit board; a liquid crystal layer between the circuit board and the substrate.

In yet another implementation of the aspect, the display device also includes a color filter constituted by color filter layers which are arranged in a cyclic manner; and a black matrix formed in a grid manner so as to partition the color filter layers; the color filter and the black matrix being disposed on a liquid crystal layer side of the counter substrate; and the one or more patterned strain gauge traces being aligned with and in contact with the black matrix on the liquid crystal layer side of the counter substrate.

In yet another implementation of the aspect, the display device also includes a color filter constituted by color filter layers which are arranged in a cyclic manner; a black matrix formed in a grid manner so as to partition the color filter layers; the color filter being disposed on a liquid crystal layer side of the substrate; the black matrix being disposed on the liquid crystal layer side of the circuit board; and the one or more patterned strain gauge traces being separated from and aligned with the black matrix on opposite sides of the liquid crystal layer.

In yet another implementation of the aspect, the display device also includes a color filter constituted by color filter layers which are arranged in a cyclic manner; a black matrix formed in a grid manner so as to partition the color filter layers; the color filter being disposed on a side of the color filter opposite of a liquid crystal layer side; the black matrix being disposed on the liquid crystal layer side of the circuit board; the one or more patterned strain gauge traces being separated from and aligned with the black matrix on opposite sides of the liquid crystal layer.

In yet another implementation of the aspect, the display device also includes a circuit board; a substrate disposed so as to face the circuit board; an organic electroluminescent (EL) layer between the circuit board and the substrate.

In yet another implementation of the aspect, the organic EL layer includes a plurality of sub-pixels; the plurality of sub-pixels is separated by color separators; the one or more patterned strain gauge traces being separated from and aligned with the color separators.

In yet another implementation of the aspect, the strain gauge sensor layer includes a first strain gauge pattern on a first surface of the strain gauge sensor layer, and a second strain gauge pattern on a second surface of the strain gauge sensor layer; the first strain gauge pattern is electrically connected to the second strain gauge pattern through at least one conductive via through the strain gauge sensor layer.

In yet another implementation of the aspect, the first strain gauge pattern is a first serpentine pattern along a first direction, and the second strain gauge pattern is a second serpentine pattern along a second direction.

In yet another implementation of the aspect, at least one of the one or more strain gauge traces is coupled to an excitation source and a sensing circuit.

In yet another implementation of the aspect, the excitation source is an alternating current (AC) excitation source or a direct current (DC) excitation source.

In yet another implementation of the aspect, each of the one or more strain gauge traces is coupled to an excitation source, the excitation sources are configured to sequentially provide excitation signals to the corresponding one or more strain gauge traces.

In yet another implementation of the aspect, each of the one or more strain gauge traces is coupled to an excitation source, the excitation sources are configured to parallelly provide excitation signals to the corresponding one or more strain gauge traces.

In yet another implementation of the aspect, the one or more strain gauge traces form at least two columns, wherein two of the at least two columns are coupled to differential inputs of a sensing integrated circuit for differential sensing.

In yet another implementation of the aspect, the touch detection layer comprises a plurality of in-cell touch sensors.

In yet another implementation of the aspect, the plurality of pixels comprises color filter elements; a light shielding layer is patterned between the plurality of color filter elements; the one or more patterned strain gauge traces of the strain gauge sensor layer overlap with the light shielding layer.

In yet another implementation of the aspect, the one or more patterned strain gauge traces comprise conductive material, and are disposed between the plurality of pixels to form a light shielding layer.

In yet another implementation of the aspect, at least one of the one or more patterned strain gauge traces is connected to a Wheatstone bridge for measuring the one or more touch forces applied to the display device.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a cross-sectional view illustrating configuration of a display panel having an integrated strain gauge sensor for touch force sensing, according to an implementation of the present application.

FIG. 2A is a diagram showing an example pattern of strain gauge traces, according to an example implementation of the present application.

FIG. 2B is a perspective view of the pattern of the strain gauge traces in FIG. 2A provided on a black matrix of a display panel.

FIG. 2C is a plan view showing the pattern of the strain gauge traces in FIG. 2A provided on a black matrix of a display panel.

FIG. 2D is an enlarged view of the box A illustrated in FIG. 2C.

FIG. 3 is an example circuit diagram of a strain gauge sensing circuit, according to an example implementation of the present application.

FIG. 4 is an example circuit diagram of an integrated strain gauge sensing circuit for multi-touch force sensing, according to an implementation of the present application.

FIG. 5 is an example circuit diagram of an integrated strain gauge sensing circuit for multi-touch force sensing, according to an implementation of the present application.

FIG. 6 is another example circuit diagram of an integrated strain gauge sensing circuit for multi-touch force sensing, according to an implementation of the present application.

FIG. 7 shows an example circuit diagram of an integrated strain gauge sensing circuit for multi-touch force sensing, according to an implementation of the present application.

FIG. 8 shows an example circuit diagram of an integrated strain gauge sensing circuit having a capacitance bridge for multi-touch force sensing, according to an implementation of the present application.

FIG. 9 shows an example circuit diagram of an integrated strain gauge sensing circuit capable of single-end sensing, according to an implementation of the present application.

FIG. 10 is a cross-sectional view illustrating configuration of a display panel 1000 having an integrated strain gauge sensor for touch force sensing, according to an implementation of the present application.

FIG. 11 is a cross-sectional view illustrating configuration of a display panel having an integrated strain gauge sensor for touch force sensing, according to an implementation of the present application.

FIG. 12 is a cross-sectional view illustrating a configuration of an organic electroluminescent (EL) display panel having an integrated strain gauge sensor, according to an implementation of the present application.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

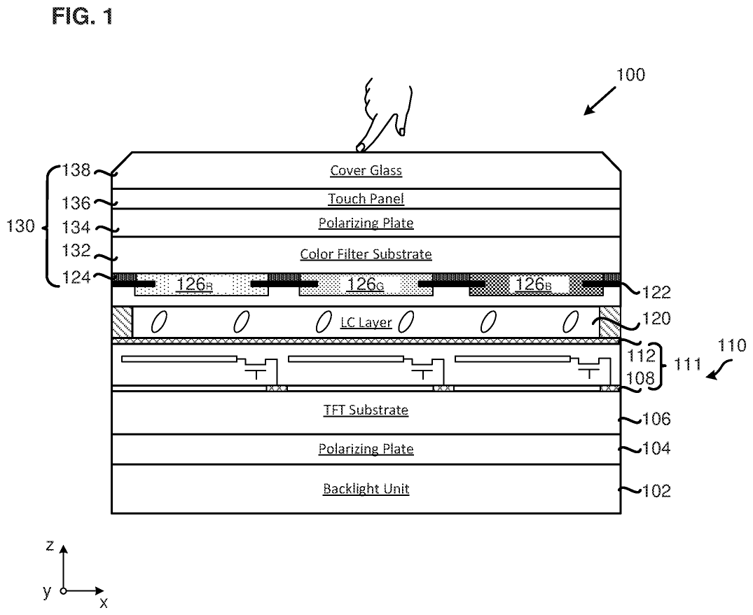

FIG. 1 is a cross-sectional view illustrating configuration of a display panel 100 having an integrated strain gauge sensor for touch force sensing, in accordance with a first implementation of the present application. The display panel 100 includes a circuit board 110, a counter substrate 130 disposed so as to face the circuit board 110, and a liquid crystal layer 120 provided between the circuit board 110 and the counter substrate 130.

The circuit board 110 includes a thin film transistor (TFT) substrate 106. The TFT substrate 106 may include TFT gate lines, TFT source lines, a TH layer, and a plurality of pixel electrodes (not explicitly shown in FIG. 1). The TFT gate lines, the TFT source lines, the TH layer, and the plurality of pixel electrodes are provided on a liquid crystal layer side of the TFT substrate. The TFT gate lines, the TFT source lines, and the TH layer are provided for switching of the plurality of pixel electrodes.

A touch detection layer (e.g., an in-cell touch sensor layer) 111 having electrodes 108 and 112 is on a liquid crystal layer 120 side of the TFT substrate 106. A polarizing plate 104 and a backlight unit 102 are provided on a side of the TFT substrate 106 that is opposite to the liquid crystal layer 120 side.

The counter substrate 130 includes a color filter (CF) substrate 132, a polarizing plate 134, a touch panel 136, and a cover glass 138. The CF substrate 132 includes a plurality of sub-pixels having color filters (e.g., color filters 126R, 126G, 126B, etc.) and a light shielding layer (e.g., a black matrix) 124, which are provided on the liquid crystal layer 120 side of the CF substrate 132.

The display panel 100 is provided with strain gauge traces 122 which are a part of a strain gauge sensor integrated in the display panel 100. The strain gauge sensor is configured to detect touch forces applied to the counter substrate 130. The strain gauge traces 122 are patterned and routed along the light shielding layer 124 to avoid negative impact on optical properties of display image. As shown in FIG. 1, the strain gauge traces 122 are formed under the light shielding layer 124 and between the color filters 126R, 126G, 126B.

In the display panel 100, the strain gauge traces 122 are integrated with the touch detection layer (e.g., an in-cell touch sensor layer) 111 to realize 3D touch sensing. The strain gauge traces 122 are in contact and aligned with the light shielding layer 124.

The strain gauge traces 122 may include conductive or semiconductor material. In a case where the strain gauge traces 122 includes a metal layer, the strain gauge layer may recycle light emitted from the backlight unit 102 thereby increasing the brightness of the display panel 100.

When a force or pressure is applied to the counter substrate 130, the display is bent, and strain gauge traces are strained due to the force. This in turn changes the current passing through the sensor. The change in strain gauge current (or voltage) is proportional to the touch force.

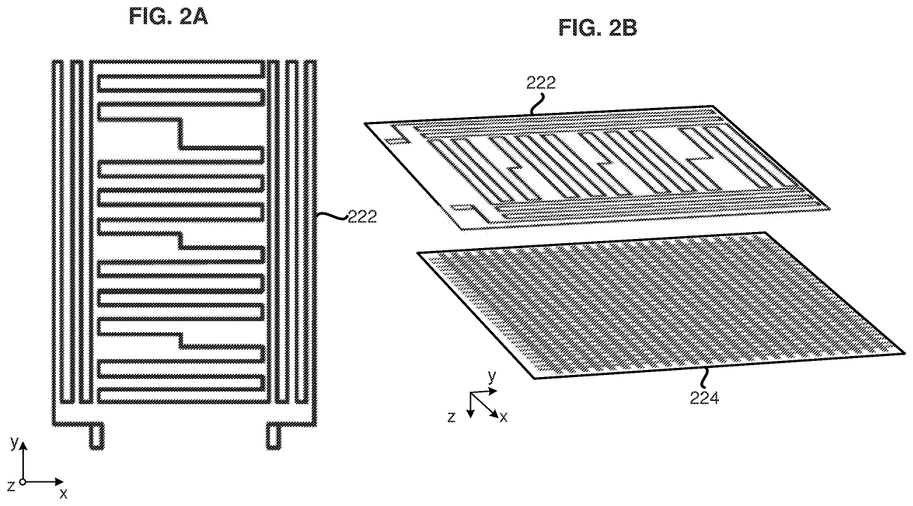

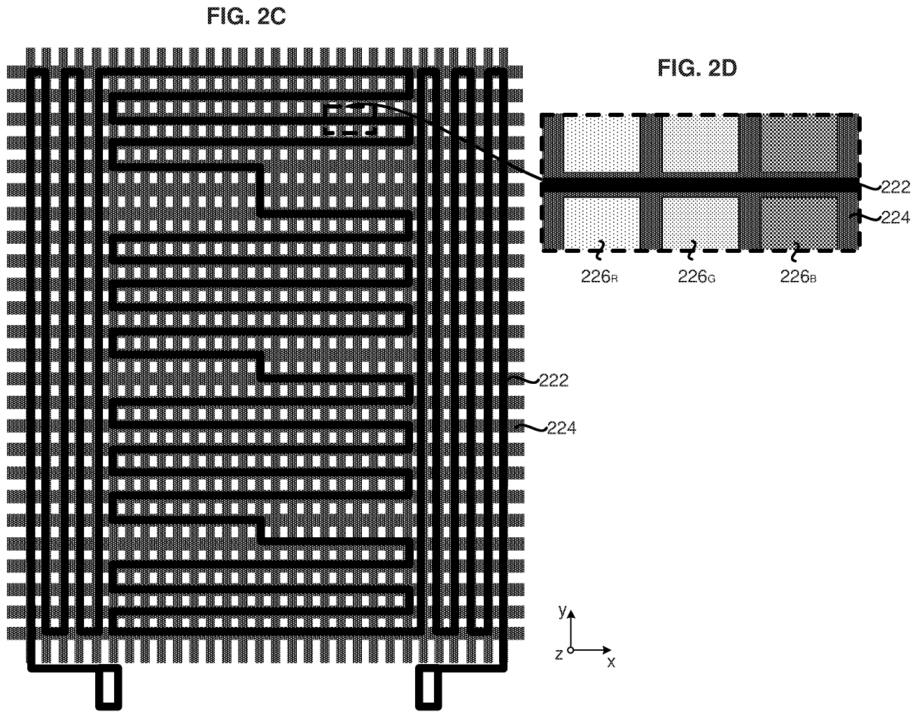

FIG. 2A is a diagram showing example strain gauge traces 222, according to an example implementation of the present application. FIG. 2B is a perspective view of the pattern of the strain gauge traces 222 in FIG. 2A provided on a light shielding layer (e.g., a black matrix) 224 of a display panel. FIG. 2C is a plan view illustrating the pattern of the strain gauge traces 222 in FIG. 2A provided on the light shielding layer 224 of a display panel. FIG. 2D is an enlarged view of the box A illustrated in FIG. 2C.

When reference to FIG. 1, The CF substrate 132 has (i) the CF substrate 132 having color filters 126R, 126G, and 126B arranged in a cyclic manner, and (ii) the light shielding layer 124 formed in a grid manner so as to partition the color filters 126R, 126G, and 126B.

The strain gauge traces 222 may correspond to the strain gauge traces 122 in FIG. 1. The light shielding layer 224 may correspond to the light shielding layer 124 in FIG. 1. The strain gauge traces 222 may be formed, by patterning, in a dark region of the light shielding layer 224 so as to extend in the x- and y-directions. Such a pattern minimizes negative optical interference and negative electrical interference that would otherwise occur if the strain gauge traces 222 were not formed in the dark regions of the light shielding layer 224.

In one implementation, when the light shielding layer 224 is made of a conductive material, the conductive material of the light shielding layer 224 may also serve as the strain gauge traces. In another implementation, an insulator may be used over the light shielding layer 224 to isolate the strain gauge traces 222 from the light shielding layer 224.

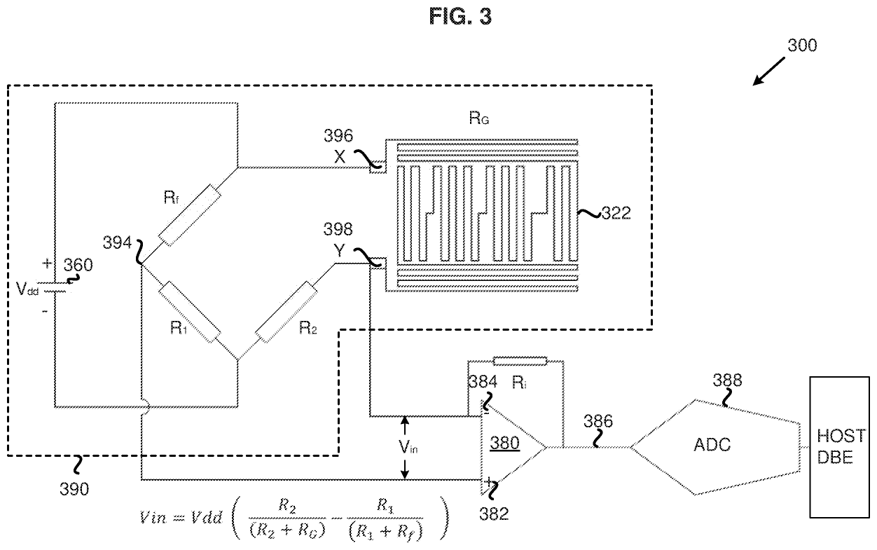

FIG. 3 is an example circuit diagram of a strain gauge sensing circuit 300, according to an example implementation of the present application. In the strain gauge sensing circuit 300, strain gauge traces 322 having resistance R_{G} is connected with R₁, R₂, and R_{f} in a Wheatstone bridge 390 at nodes 396 and 398. A voltage source 360 is connected between a positive and a negative input nodes of the Wheatstone bridge 390. The voltage source 360 is configured to supply a voltage, Vdd, to the Wheatstone bridge 390. In one implementation, the positive and negative input nodes of the Wheatstone bridge 390 may be coupled to a current source supplying a current to the Wheatstone bridge 390. The Wheatstone bridge 390 has a positive output node 394 electrically connected to a positive terminal 382 of a differential amplifier 380, and a negative output node 398 electrically connected to a negative terminal 384 of the differential amplifier 380. The differential amplifier 380 may be a part of a sensing integrated circuit (IC) of the strain gauge sensing circuit 300, and is configured to provide a conditioned composite output signal 386 as a function of an external force/pressure stimulus detected by the Wheatstone bridge 390.

For example, a touch force applied on the display panel can be measured by the change in resistance in the display integrated strain gauge traces 322 of the strain gauge sensing circuit 300. The voltage at the node 398 of the strain gauge traces 322 and the voltage at the node 394 are respectively applied across the negative and positive terminals of the differential amplifier 380. The difference in voltage, Vin, between the nodes 394 and 398 may be expressed by:

$$Vin = Vdd ( \frac{{R}_{2}}{( {R}_{2} + {R}_{G} )} - \frac{{R}_{1}}{( {R}_{1} + {R}_{f} )} ) \qquad Equation ( 1 )$$

The output signal 386 of the differential amplifier 380 is a conditioned composite output signal as a function of an external force stimulus detected by the Wheatstone bridge 390. The output signal 386 of the differential amplifier 380 may be provided to an analog to digital converter (ADC) 388. The converted output signal is sent to the digital backend of the host device for further processing.

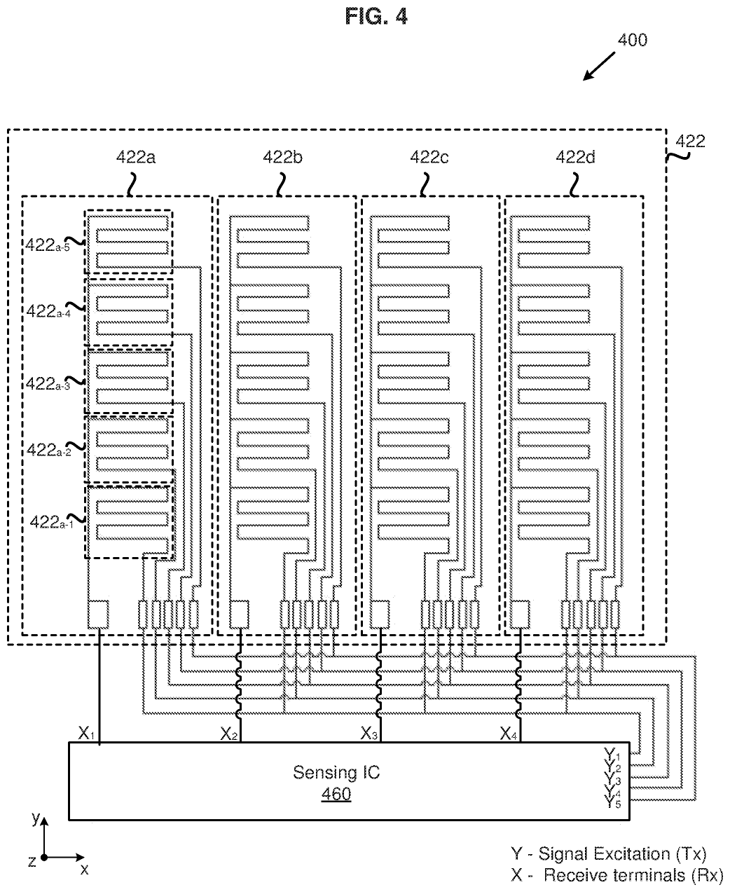

FIG. 4 is an example circuit diagram of an integrated strain gauge sensing circuit 400 for multi-touch force sensing, according to an implementation of the present application. In FIG. 4, the integrated strain gauge sensing circuit 400 includes strain gauge traces 422 patterned in a plurality of strain gauge trace columns 422a, 422b, 422c, and 422d in a single layer. In each of the strain gauge trace columns 422a, 422b, 422c, and 422d, there are independent excited strain gauge traces for multi-touch force sensing. For example, in the strain gauge trace column 422a, an excitation signal Y1 is provided to a strain gauge trace 422a-1, which is coupled to the receiving terminal X1 of a sensing IC 460. Similarly, excitation signals Y2, Y3, Y4, and Y5 are provided to strain gauge traces 422a-2, 422a-3, 422a-4, and 422a-5, respectively, which are coupled to the receiving terminal X1, respectively, of the sensing IC 460 for sensing. It should be noted that that each of strain gauge traces 422a-1, 422a-2, 422a-3, 422a-4, and 422a-5 may be coupled to a Wheatstone bridge (e.g., Wheatstone bridge 390 in FIG. 3) in the sensing IC 460. Similar configurations may apply to the strain gauge trace columns 422b, 422c, and 422d. As such, localized multi-touch forces can be sensed by the integrated strain gauge sensing circuit 400.

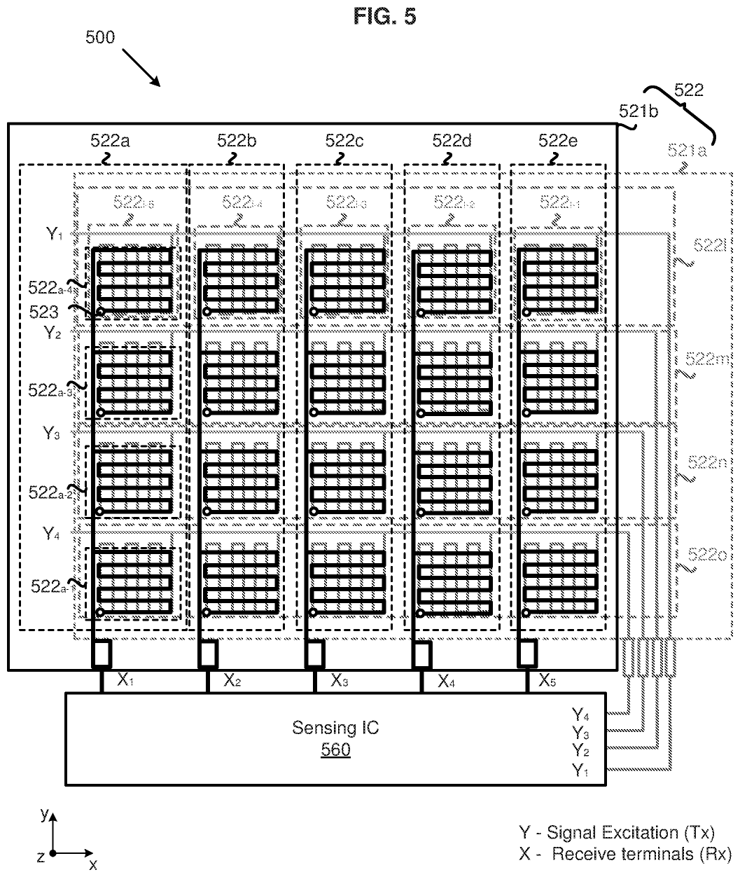

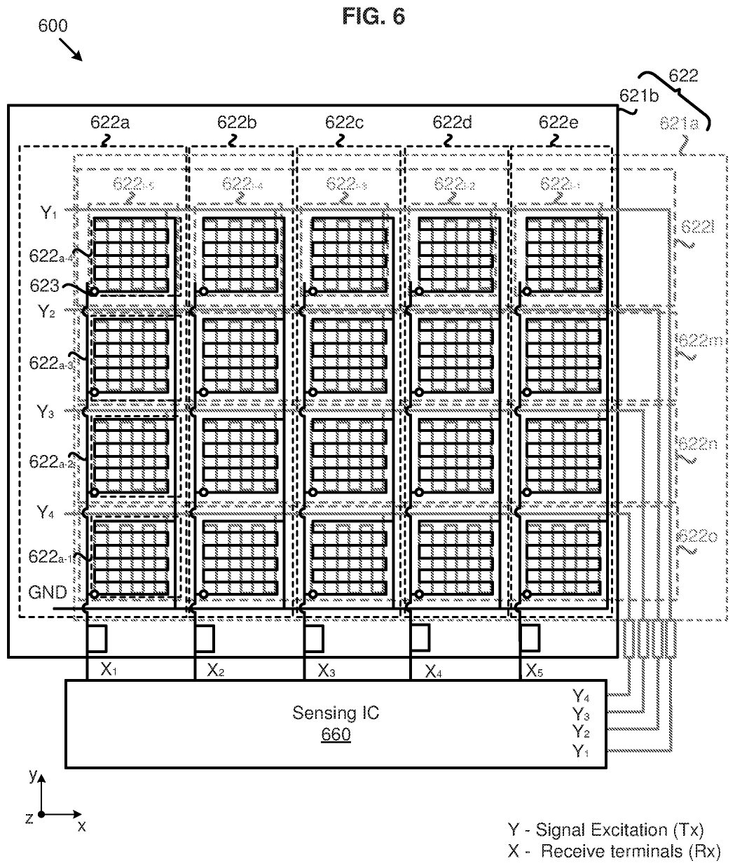

FIG. 5 is an example circuit diagram of an integrated strain gauge sensing circuit 500 for multi-touch force sensing, according to an implementation of the present application. In FIG. 5, the integrated strain gauge sensing circuit 500 includes strain gauge traces 522 patterned in two layers connected to each other through one or more conductive vias.

In the first strain gauge layer 521a, the strain gauge traces 522 include a plurality of strain gauge trace rows 522l, 522m, 522n, and 522o along the x-direction. Each of the strain gauge trace rows 522l, 522m, 522n, and 522o is independently excited for multi-touch force sensing. For example, in the strain gauge trace row 522l, an excitation signal Y1 is provided to the strain gauge trace row 522l having strain gauge traces 522l-1, 522l-2, 522l-3, 522l-4, and 522l-5. The strain gauge trace rows 522m, 522n, and 522o are excited by excitation signals Y2, Y3, and Y4, respectively.

In the second strain gauge layer 521b, the strain gauge traces 522 includes a plurality of strain gauge trace columns 522a, 522b, 522c, 522d, and 522e along the y-direction. The strain gauge trace columns 522a, 522b, 522c, 522d, and 522e in the second layer are independently coupled to receiving terminals X1, X2, X3, X4, and X5, respectively, of the sensing IC 560. For example, the strain gauge trace columns 522 includes strain gauge traces 522a-1, 522a-2, 522a-3, and 522a-4 coupled to the receiving terminal X1 of the sensing IC 560.

The strain gauge traces in the first strain gauge layer 521a and the strain gauge traces in the second strain gauge layer 521b are connected to one another through one or more conductive vias. For example, in the strain gauge trace row 522l, the excitation signal Y1 is provided to strain gauge traces 522l-1, 522l-2, 522l-3, 522l-4, and 522l-5. As an example, the excitation signal Y1 is provided to the strain gauge trace 522l-5 in the strain gauge trace row 522l in the first strain gauge layer 521a. The strain gauge trace 522l-5 is electrically connected to the strain gauge trace 522a-4 in the strain gauge trace column 522a in the second strain gauge layer 521b through a conductive via 523. The strain gauge trace 522a-4 is also electrically connected to the receiving terminal X1 of the sensing IC 560. As such, each strain gauge trace in the first strain gauge layer 521a is electrically connected to a corresponding strain gauge trace in the second strain gauge layer 521b through a conductive via. The integrated strain gauge sensing circuit 500 is configured to detect or sense localized multi-touch force. In some implementations, the first layer and the second layer are disposed on opposite surfaces of a dielectric substrate (not explicitly shown), where the conductive vias extend through the entire thickness of the dielectric substrate.

In some implementations, the strain gauge traces 522 may include more than two layers made of multiple conductive or semiconductor layers separated by, for example, one or more dielectric layers (not explicitly shown in FIG. 5). In FIG. 5, the first and second strain gauge layers are separated in the x- and y-directions and connected at the intersection to make the matrix of strain gauges.

FIG. 6 is another example circuit diagram of an integrated strain gauge sensing circuit 600 for multi-touch force sensing, according to an implementation of the present application. In FIG. 6, the integrated strain gauge sensing circuit 600 includes strain gauge traces 622 patterned in two layers connected to each other through one or more conductive vias.

In the first strain gauge layer 621a, the strain gauge traces 622 include a plurality of strain gauge trace rows 622l, 622m, 622n, and 622o along the x-direction. Each of the strain gauge trace rows 622l, 622m, 622n, and 622o is independently excited for multi-touch force sensing. For example, in the strain gauge trace row 622l, an excitation signal Y1 is provided to the strain gauge trace row 622l having strain gauge traces 622l-1, 622l-2, 622l-3, 622l-4, and 622l-5. The strain gauge trace rows 622m, 622n, and 622o are excited by excitation signals Y2, Y3, and Y4, respectively.

In the second strain gauge layer 621b, the strain gauge traces 622 includes a plurality of strain gauge trace columns 622a, 622b, 622c, 622d, and 622e along the y-direction. The strain gauge trace columns 622a, 622b, 622c, 622d, and 622e in the second layer are independently coupled to receiving terminals X1, X2, X3, X4, and X5, respectively, of a sensing IC 660.

The strain gauge traces in the first strain gauge layer 621a and the strain gauge traces in the second strain gauge layer 621b are connected to one another through one or more conductive vias. For example, in the strain gauge trace row 622l, the excitation signal Y1 is provided to strain gauge traces 622l-1, 622l-2, 622l-3, 622l-4, and 622l-5. As an example, the excitation signal Y1 is provided to the strain gauge trace 622l-5 in the strain gauge trace row 622l in the first strain gauge layer 621a. The strain gauge trace 622l-5 is electrically connected to the strain gauge trace 622a-4 in the strain gauge trace column 622a in the second strain gauge layer 621b through a conductive via 623. The strain gauge trace 622a-4 is also electrically connected to the receiving terminal X1 of the sensing IC 660. As such, each strain gauge trace in the first strain gauge layer 621a is electrically connected to a corresponding strain gauge trace in the second strain gauge layer 621b through a conductive via. As shown in FIG. 6, each of the strain gauge traces 622a-1, 622a-2, 622a-3, and 622a-4 in the strain gauge trace column 622a is also coupled to a reference node (e.g., a ground node). Similarly, each of the strain gauge traces in the strain gauge trace columns 622b, 622c, 622d, and 622e, are also coupled to the reference node.

The integrated strain gauge sensing circuit 600 is configured to detect or sense localized multi-touch force. In some implementations, the first layer and the second layer are disposed on opposite surfaces of a dielectric substrate (not explicitly shown), where the conductive vias extend through the entire thickness of the dielectric substrate.

In some implementations, the strain gauge traces 622 may include more than two layers made of multiple conductive or semiconductor layers separated by, for example, one or more dielectric layers (not explicitly shown in FIG. 6). In FIG. 6, the first and second strain gauge layers are separated in the x- and y-directions and connected at the intersection to make the matrix of strain gauges.

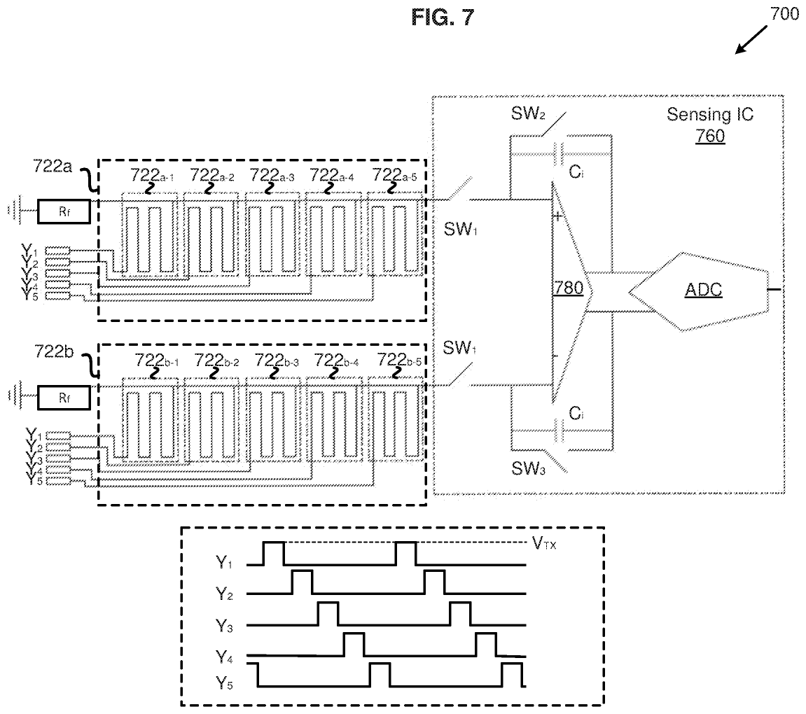

FIG. 7 shows an example circuit diagram of an integrated strain gauge sensing circuit 700 for multi-touch force sensing, according to an implementation of the present application. As shown in FIG. 7, the strain gauge trace columns 722a and 722b may be selectively input to an amplifier 780 of a sensing IC 760.

For example, in the strain gauge trace column 722a, excitation signals Y1, Y2, Y3, Y4, and Y5 may be provided to strain gauge traces 722a-1, 722a-2, 722a-3, 722a-4, and 722a-5, respectively, in the strain gauge trace column 722a. In the present implementation, the excitation signals Y1, Y2, Y3, Y4, and Y5 may be sequentially applied to the strain gauge traces 722a-1, 722a-2, 722a-3, 722a-4, and 722a-5. Similarly, in the strain gauge trace column 722b, excitation signals Y1, Y2, Y3, Y4, and Y5 may be provided to the strain gauge traces 722b-1, 722b-2, 722b-3, 722b-4, and 722b-5, respectively, in the strain gauge trace column 722b. In the present implementations, the excitation signals Y1, Y2, Y3, Y4, and Y5 may be sequentially applied to strain gauge traces 722b-1, 722b-2, 722b-3, 722b-4, and 722b-5.

The switch SW1 may is controlled by the sensing IC 760 to select one of the strain gauge trace columns 722a and 722b to input to the amplifier 780. For example, when the strain gauge trace column 722a is selected, the switch SW1 is closed between the strain gauge trace column 722a and an input of the amplifier 780, and is open between the strain gauge trace column 722b and the other input of the amplifier 780. When the strain gauge trace column 722a is selected, switch SW2 is open, and switch SW3 is closed. Thus, the strain gauge traces 722a-1, 722a-2, 722a-3, 722a-4, and 722a-5 of the strain gauge trace column 722a can be sequentially sensed by the sensing IC 760.

In another example, when the strain gauge trace column 722b is selected, the switch SW1 is closed between the strain gauge trace column 722b and an input of the amplifier 780, and is open between the strain gauge trace column 722a and the other input of the amplifier 780. When the strain gauge trace column 722b is selected, switch SW2 is closed, and switch SW3 is open. Thus, the strain gauge traces 722b-1, 722b-2, 722b-3, 722b-4, and 722b-5 of the strain gauge trace column 722b can be sequentially sensed by the sensing IC 760.

In one implementation, each of the strain gauge traces 722a-1, 722a-2, 722a-3, 722a-4, and 722a-5 in strain gauge trace column 722a and each of the strain gauge traces 722b-1, 722b-2, 722b-3, 722b-4, and 722b-5 in strain gauge trace column 722b has a resistance R_{G}. Each of the strain gauge trace columns 722a and 722b is connected to the ground through a resistance (Rf).

For example, the voltage, Vin, across the inputs of the amplifier 780 may be expressed as:

$$Vin \approx {V}_{T x} \frac{{R}_{f} . {R}_{G}}{{( {R}_{f} + {R}_{G} )}^{2}} σ \qquad Equation ( 2 )$$

where σ is a strain coefficient, which is proportional to the amount of force/pressure applied to the corresponding strain gauge trace.

In another implementation, the strain gauge traces may be excited by AC signals, and voltage divider based on resistors may be used. In another implementation, the strain gauge trace rows can be scanned, and sequential or parallel driving may be used to excite the strain gauge traces. In another implementation, differential sensing may be used where two strain gauge trace columns are applied to the inputs of the amplifier. Differential sensing may result in better sensitivity.

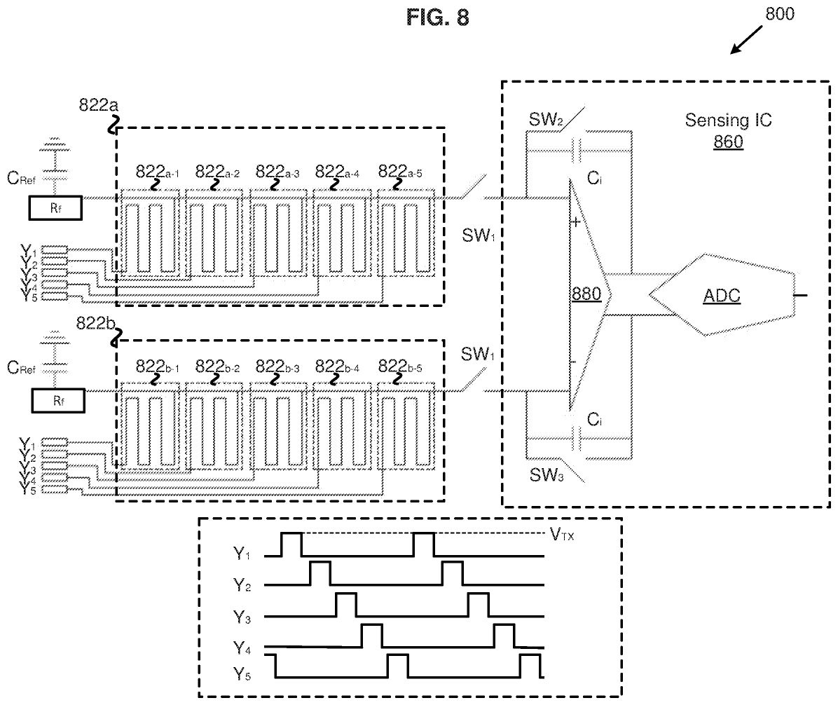

FIG. 8 shows an example circuit diagram of an integrated strain gauge sensing circuit 800 having a capacitance bridge for multi-touch force sensing, according to an implementation of the present application. As shown in FIG. 8, the strain gauge trace columns 822a and 822b may be selectively input to an amplifier 880 of a sensing IC 860. For example, in the strain gauge trace column 822a, excitation signals Y1, Y2, Y3, Y4, and Y5 may be provided to strain gauge traces 822a-1, 822a-2, 822a-3, 822a-4, and 822a-5, respectively, in the strain gauge trace column 822a. In the present implementations, the excitation signals Y1, Y2, Y3, Y4, and Y5 may be sequentially applied to the strain gauge traces 822a-1, 822a-2, 822a-3, 822a-4, and 822a-5. Similarly, in the strain gauge trace column 822b, excitation signals Y1, Y2, Y3, Y4, and Y5 may be provided to the strain gauge traces 822b-1, 822b-2, 822b-3, 822b-4, and 822b-5, respectively, in the strain gauge trace column 822b. In the present implementations, the excitation signals Y1, Y2, Y3, Y4, and Y5 may be sequentially applied to strain gauge traces 822b-1, 822b-2, 822b-3, 822b-4, and 822b-5.

The switch SW1 may is controlled by the sensing IC 860 to select one of the strain gauge trace columns 822a and 822b to input to the amplifier 880. For example, when the strain gauge trace column 822a is selected, the switch SW1 is closed between the strain gauge trace column 822a and an input of the amplifier 880, and is open between the strain gauge trace column 822b and the other input of the amplifier 880. When the strain gauge trace column 822a is selected, switch SW2 is open, and switch SW3 is closed. Thus, the strain gauge traces 822a-1, 822a-2, 822a-3, 822a-4, and 822a-5 of the strain gauge trace column 822a can be sequentially sensed by the sensing IC 860.

In another example, when the strain gauge trace column 822b is selected, the switch SW1 is closed between the strain gauge trace column 822b and an input of the amplifier 880, and is open between the strain gauge trace column 822a and the other input of the amplifier 880. When the strain gauge trace column 822b is selected, switch SW2 is closed, and switch SW3 is open. Thus, the strain gauge traces 822b-1, 822b-2, 822b-3, 822b-4, and 822b-5 of the strain gauge trace column 822b can be sequentially sensed by the sensing IC 860. As such, the integrated strain gauge sensing circuit 800 enables multi-touch force sensing using capacitance bridge(s).

In one implementation, each of the strain gauge traces 822a-1, 822a-2, 822a-3, 822a-4, and 822a-5 in strain gauge trace column 822a and each of the strain gauge traces 822b-1, 822b-2, 822b-3, 822b-4, and 822b-5 in strain gauge trace column 822b has a resistance R_{G}. Each of the strain gauge trace columns 822a and 822b is connected to the ground through a resistance (Rf) and a reference capacitor C_{Ref}.

For example, the voltage, Vin, across the inputs of the amplifier 880 may be expressed by:

$$Vin \approx {V}_{T x} \frac{j ω {C}_{Ref} . {R}_{G}}{{( \frac{1}{j ω {c}_{Ref}} {R}_{f} + {R}_{G} )}^{2}} σ \qquad Equation ( 3 )$$

where σ is a strain coefficient, which is proportional to the amount of force/pressure applied to the corresponding strain gauge trace.

In another implementation, the strain gauge traces may be excited by AC signals, and voltage divider based on capacitors may be used. In another implementation, the strain gauge trace rows can be scanned, and sequential or parallel driving may be used to excite the strain gauge traces. In another implementation, differential sensing may be used where two strain gauge trace columns are applied to the inputs of the amplifier. Differential sensing may result in better sensitivity.

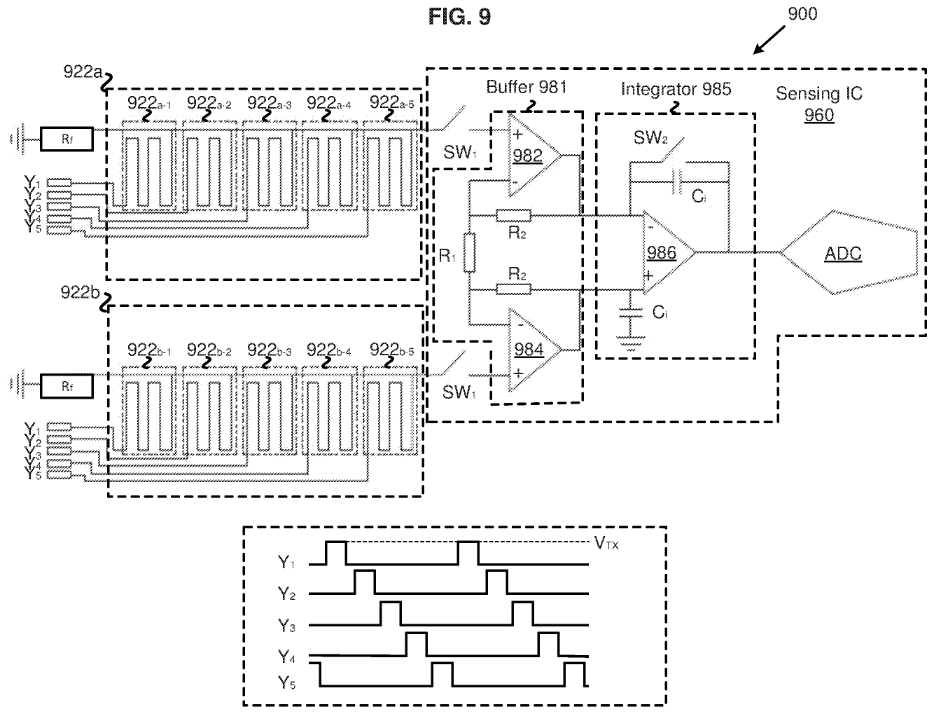

FIG. 9 shows an example circuit diagram of an integrated strain gauge sensing circuit 900 capable of single-end sensing according to an implementation of the present application. As shown in FIG. 9, the strain gauge trace columns 922a and 922b may be selectively input to a buffer 981 of a sensing IC 960.

For example, in the strain gauge trace column 922a, excitation signals Y1, Y2, Y3, Y4, and Y5 may be provided to strain gauge traces 922a-1, 922a-2, 922a-3, 922a-4, and 922a-5, respectively, in the strain gauge trace column 922a. In the present implementations, the excitation signals Y1, Y2, Y3, Y4, and Y5 may be sequentially applied to the strain gauge traces 922a-1, 922a-2, 922a-3, 922a-4, and 922a-5. Similarly, in the strain gauge trace column 922b, excitation signals Y1, Y2, Y3, Y4, and Y5 may be provided to the strain gauge traces 922b-1, 922b-2, 922b-3, 922b-4, and 922b-5, respectively, in the strain gauge trace column 922b. In the present implementations, the excitation signals Y1, Y2, Y3, Y4, and Y5 may be sequentially applied to strain gauge traces 922b-1, 922b-2, 922b-3, 922b-4, and 922b-5.

In FIG. 9, the strain gauge trace column 922a is coupled to the positive terminal of an amplifier 982 of the buffer 981. The strain gauge trace column 922b is coupled to the positive terminal of an amplifier 984 of the buffer 981. The negative terminals of the amplifiers 982 and 984 are coupled to the respective outputs of the amplifiers through a resistance R2.

The buffer 981 is coupled to an integrator 985. As can be seen in FIG. 9, the output of the amplifier 982 is coupled to the negative terminal of an amplifier 986 of the integrator 985, while the output of the amplifier 984 is coupled to the positive terminal of the amplifier 986 of the integrator 985.

The switch SW1 may is controlled by the sensing IC 960 to select one of the strain gauge trace columns 922a and 922b to input to the buffer 981. For example, when the strain gauge trace column 922a is selected, the switch SW1 is closed between the strain gauge trace column 922a and the positive terminal of the amplifier 982, and is open between the strain gauge trace column 922b and the positive input of the amplifier 984. When the strain gauge trace column 922a is selected, switch SW2 is open. Thus, the strain gauge traces 922a-1, 922a-2, 922a-3, 922a-4, and 922a-5 of the strain gauge trace column 922a can be sequentially sensed by the sensing IC 960.

In another example, when the strain gauge trace column 922b is selected, the switch SW1 is closed between the strain gauge trace column 922b and the positive terminal of the amplifier 984, and is open between the strain gauge trace column 922a and the positive terminal of the amplifier 986. When the strain gauge trace column 922b is selected, switch SW2 is closed. Thus, the strain gauge traces 922b-1, 922b-2, 922b-3, 922b-4, and 922b-5 of the strain gauge trace column 922b can be sequentially sensed by the sensing IC 960. As such, the integrated strain gauge sensing circuit 900 enables single-end sensing using strain gauge trace columns.

In one implementation, each of the strain gauge traces 922a-1, 922a-2, 922a-3, 922a-4, and 922a-5 in strain gauge trace column 922a and each of the strain gauge traces 922b-1, 922b-2, 922b-3, 922b-4, and 922b-5 in strain gauge trace column 922b has a resistance R_{G}. Each of the strain gauge trace columns 922a and 922b is connected to the ground through a resistance (Rf). Thus, Equation (2) above may be used to determine the amount of force/pressure applied to the corresponding strain gauge trace(s).

In another implementation, the strain gauge traces may be excited by AC signals, and voltage divider based on resistors may be used. In another implementation, the strain gauge trace rows can be scanned, and sequential or parallel driving may be used to excite the strain gauge traces. In another implementation, differential sensing may be used where two strain gauge trace columns are applied to the inputs of the amplifier. Differential sensing may result in better sensitivity.

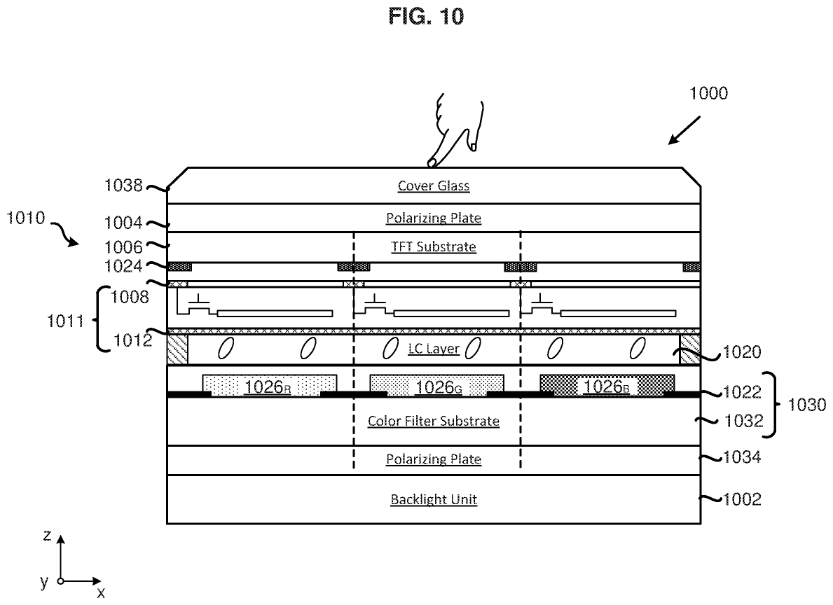

FIG. 10 is a cross-sectional view illustrating configuration of a display panel 1000 having an integrated strain gauge sensor for touch force sensing, according to an implementation of the present application. The display panel 1000 has a reversed display stack structure, and includes a circuit board 1010, a substrate 1030 disposed so as to face the circuit board 1010, and a liquid crystal layer 1020 provided between the circuit board 1010 and the substrate 1030.

The circuit board 1010 includes a thin film transistor (TFT) substrate 1006. The TFT substrate 1006 may include TFT gate lines, TFT source lines, a TH layer, and a plurality of pixel electrodes (not explicitly shown in FIG. 10). The TFT gate lines, the TFT source lines, the TH layer, and the plurality of pixel electrodes are provided on a liquid crystal layer side of the TFT substrate 1006. The TFT gate lines, the TFT source lines, and the TH layer are provided for switching of the plurality of pixel electrodes.

A touch detection layer (e.g., an in-cell touch sensor layer) 1011 having electrodes 1008 and 1012 is on the liquid crystal layer 1020 side of the circuit board 1010. A polarizing plate 1004 is provided on a side of the TFT substrate 1006 that is opposite to the liquid crystal layer 1020 side. The circuit board 1010 also includes a light shielding layer (e.g., a black matrix) 1024, which is provided on the liquid crystal layer 1020 side of the TFT substrate 1006. The cover glass 1038 is disposed on a side of the polarizing plate 1004 that is opposite of the TFT substrate 1006 side.

The substrate 1030 includes a color filter (CF) substrate 1032. The CF substrate 1032 includes a plurality of sub-pixels having color filters (e.g., color filters 1026R, 1026G, 1026B, etc.). A polarizing plate 1034 and a backlight unit 1002 are provided on a side of the CF substrate 1032 that is opposite to the liquid crystal layer 1020 side.

The display panel 1000 is provided with strain gauge traces 1022 which are configured to detect a force applied to the substrate 1030. The strain gauge traces 1022 are patterned between the color filters 1026R, 1026G, 1026B, and routed along the light shielding layer 1024 to avoid negative impact on optical properties of display image. As shown in FIG. 10, the strain gauge traces 1022 are formed on the CF substrate 1032 and between the color filters 1026R, 1026G, 1026B. The strain gauge traces 1022 are situated below and aligned with the light shielding layer 1024 in the z-direction.

In the display panel 1000, the strain gauge traces 1022 are integrated with the touch detection layer (e.g., an in-cell touch sensor layer) 1011 to realize 3D touch sensing. The strain gauge traces 1022 are disposed below the light shielding layer 1024, but not on the same glass substrate.

In one implementation, the strain gauge traces 1022 may include conductive or semiconductor material. In a case where the strain gauge traces 1022 includes a metal layer, the strain gauge layer may recycle light emitted from the backlight unit 1002 thereby increasing the brightness of the display panel 1000.

When a force or pressure is applied to the substrate 1030, the display is bent, and strain gauge traces are strained due to the force. This in turn changes the current passing through the sensor. The change in strain gauge current (or voltage) is proportional to the touch-press force.

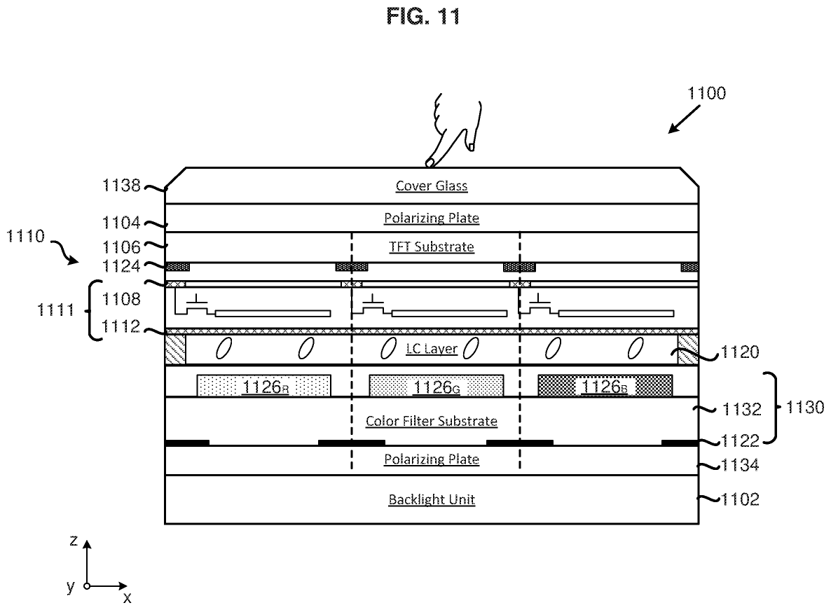

FIG. 11 is a cross-sectional view illustrating configuration of a display panel 1100 having an integrated strain gauge sensor for touch force sensing, according to an implementation of the present application. The display panel 1100 has a reversed display stack structure, and includes a circuit board 1110, a substrate 1130 disposed so as to face the circuit board 1110, and a liquid crystal layer 1120 provided between the circuit board 1110 and the substrate 1130.

The circuit board 1110 includes a thin film transistor (TFT) substrate 1106. The TFT substrate 1106 may include TFT gate lines, TFT source lines, a TH layer, and a plurality of pixel electrodes (not explicitly shown in FIG. 11). The TFT gate lines, the TFT source lines, the TH layer, and the plurality of pixel electrodes are provided on a liquid crystal layer side of the TFT substrate 1106. The TFT gate lines, the TFT source lines, and the TH layer are provided for switching of the plurality of pixel electrodes.

A touch detection layer (e.g., an in-cell touch sensor layer) 1111 having electrodes 1108 and 1112 is on the liquid crystal layer 1120 side of the circuit board 1110. A polarizing plate 1104 is provided on a side of the TFT substrate 1106 that is opposite to the liquid crystal layer 1120 side. The circuit board 1110 also includes a light shielding layer (e.g., a black matrix) 1124, which is provided on the liquid crystal layer 1120 side of the TFT substrate 1106. A cover glass 1138 is disposed on a side of the polarizing plate 1104 that is opposite of the TFT substrate 1106 side.

The substrate 1130 includes a color filter (CF) substrate 1132. The CF substrate 1132 includes a plurality of sub-pixels having color filters (e.g., color filters 1126R, 1126G, 1126B, etc.). As shown in FIG. 11, the color filters 1126R, 1126G, 1126B are formed on a surface of the CF substrate 1132 on the liquid crystal layer 1120 side. A polarizing plate 1134 and a backlight unit 1102 are provided on a side of the CF substrate 1132 that is opposite to the liquid crystal layer 1120 side.

The display panel 1100 is provided with strain gauge traces 1122 which are configured to detect a force applied to the substrate 1130. The strain gauge traces 1122 are patterned between the color filters 1126R, 1126G, 1126B, and routed along the light shielding layer 1024 to avoid negative impact on optical properties of display image. In comparison to the strain gauge traces 1022 in FIG. 10, the strain gauge traces 1122 are patterned on a surface of the polarizing plate 1134 on the liquid crystal layer 1120 side. The strain gauge traces 1122 are routed along the light shielding layer 1124 to avoid negative impact on optical properties of display image.

As shown in FIG. 11, the strain gauge traces 1122 are formed between the color filters 1126R, 1126G, 1126B. The strain gauge traces 1122 are situated below both the light shielding layer 1124 and the color filters 1126R, 1126G, 1126B in the z-direction.

In the display panel 1100, the strain gauge traces 1122 are disposed below the light shielding layer 1124, but not on the same substrate. In one implementation, the strain gauge traces 1122 may include conductive or semiconductor material. In a case where the strain gauge traces 1122 includes a metal layer, the strain gauge layer may recycle light emitted from the backlight unit 1102 thereby increasing the brightness of the display panel 1100.

When a force or pressure is applied to the substrate 1130, the display is bent, and strain gauge traces are strained due to the force. This in turn changes the current passing through the sensor. The change in strain gauge current (or voltage) is proportional to the touch-press force.

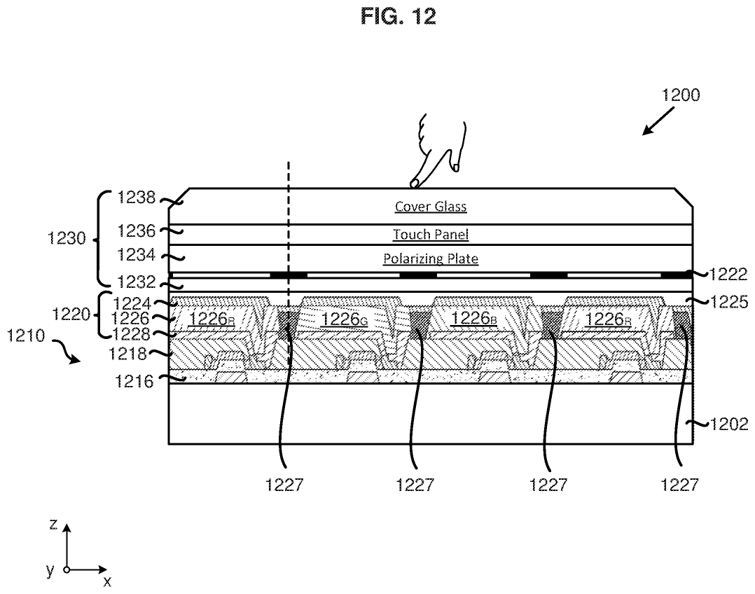

FIG. 12 is a cross-sectional view illustrating a configuration of an organic electroluminescent (EL) display panel 1200 having an integrated strain gauge sensor, according to an implementation of the present application. As illustrated in FIG. 12, the organic EL display panel 1200 includes a support substrate 1202, a circuit board 1210, an organic light emission layer 1220, and a substrate 1230.

The circuit board 1210 includes a thin film transistor (TFT) substrate 1216 having TFTs formed thereon, an interlayer insulating film 1218 insulating the TFTs in the TFT substrate 1216.

The organic light emission layer 1220 is disposed over the interlayer insulating film 1218. The organic light emission layer 1220 includes an upper electrode (e.g., anode electrode) layer 1224, an organic EL layer 1226 (e.g., having a plurality of sub-pixels with organic EL elements 1226R, 1226G, and 1226B), a lower electrode (e.g., cathode electrode) layer 1228, and a sealing layer 1225 over the upper electrode layer 1224. The organic EL elements are disposed in a display region where the sub-pixels are disposed in a matrix form to display images.

The organic EL layer 1226 includes one or more light emitting elements capable of emitting light at high luminance with a low voltage direct current driving. The lower electrode layer 1228, the organic EL layer 1226 and the upper electrode layer 1224 are layered in this order from the circuit board 1210 side. In the present implementation, a layer between the lower electrode layer 1228 and the upper electrode layer 1224 is collectively referred to as the organic EL layer 1226. The organic EL layer 1226 is disposed in each pixel.

Moreover, an optical adjustment layer configured to carry out optical adjustment, and an electrode protection layer configured to protect the electrode may be formed on the upper electrode layer 1224. In this implementation, the organic EL layer 1226 formed in each pixel, the electrode layers (e.g., the lower electrode layer 1228 and upper electrode layer 1224), and the optical adjustment layer and the electrode protection layer (not explicitly shown in FIG. 12) are collectively referred to as the organic light emission layer 1220.

The lower electrode layer 1228 is formed on the interlayer insulating film 1218. The lower electrode layer 1228 injects (supplies) holes into the organic EL layer 1226, and the upper electrode layer 1224 injects electrons into the organic EL layer 1226. In the present implementation, organic EL elements 1226R, 1226G, and 1226B are separated by a light shielding layer (e.g., color separators) 1227.

The organic EL elements 1226R, 1226G, and 1226B and their respective upper electrodes in the upper electrode layer 1224 are covered by the sealing layer 1225.

The substrate 1230 includes an insulating layer 1232, a polarizing plate 1234, a touch panel 1236, and a cover glass 1238. The insulating layer 1232 is disposed over the sealing layer 1225. The insulating layer 1232 may include an insulating material with a small Young's modulus so as to allow strain gauge traces 1222 to bend.

The organic EL display panel 1200 is provided with the strain gauge traces 1222 which are configured to detect a force applied to the substrate 1230. The touch panel 1236 may include one or more on-cell touch sensors in a touch detection layer for detecting one or more touch locations on the substrate 1230.

As shown in FIG. 12, the strain gauge traces 1222 are disposed above an area between the pixels, and aligned with the light shielding layer (e.g., color separators) 1227. For example, the strain gauge traces 1222 are disposed above the light shielding layer 1227 and between the organic EL layers 1226R, 1226G, and 1226B. The strain gauge traces 1222 are patterned and routed along the light shielding layer 1227 to avoid negative impact on optical properties (e.g., help recycling light and improve color contrast) of display image.

In the organic EL display panel 1200, the strain gauge traces 1222 are integrated with the organic EL display. In one implementation, the strain gauge traces may include conductive or semiconductor material. In a case where the strain gauge traces 1222 includes a metal layer, the strain gauge layer may recycle light emitted from the organic EL layer 1226 thereby increasing the brightness of the organic EL display panel 1200.

When a force or pressure is applied to the substrate 1230, the display is bent, and strain gauge traces are strained due to the force. This in turn changes the current passing through the sensor. The change in strain gauge current (or voltage) is proportional to the touch-press force.

From the above description, it is manifested that various techniques may be used for implementing the concepts described in the present application without departing from the scope of those concepts. Moreover, while the concepts have been described with specific reference to certain implementations, a person of ordinary skill in the art may recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A display device comprising:
a touch detection layer for detecting one or more touch locations on the display device;
a strain gauge sensor layer for sensing one or more touch forces applied to the display device, the strain gauge layer being separate from the touch detection layer;
one or more patterned strain gauge traces in the strain gauge sensor layer;
a plurality of pixels;
wherein the one or more patterned strain gauge traces are formed between the plurality of pixels;
wherein at least one of the one or more patterned strain gauge traces has a serpentine pattern,
wherein the strain gauge sensor layer includes a first strain gauge pattern on a first surface of the strain gauge sensor layer, and a second strain gauge pattern on a second surface of the strain gauge sensor layer;
the first strain gauge pattern is electrically connected to the second strain gauge pattern through at least one conductive via through the strain gauge sensor layer;
wherein a strain gauge trace for the first strain gauge pattern and a strain gauge trace for the second strain gauge pattern are overlapping.

2. The display device of claim 1, further comprising a light shielding layer patterned between the plurality of pixels, wherein the one or more patterned strain gauge traces overlap with the light shielding layer.

3. The display device of claim 1, further comprising:
a liquid crystal layer between a color filter substrate and the touch detection layer;
wherein the strain gauge sensor layer is disposed between the color filter substrate and the liquid crystal layer.

4. The display device of claim 1, further comprising:
a circuit board;
a substrate disposed so as to face the circuit board;
a liquid crystal layer between the circuit board and the substrate.

5. The display device of claim 4, further comprising:
a color filter constituted by color filter layers which are arranged in a cyclic manner;
a black matrix formed in a grid manner so as to partition the color filter layers;
the color filter and the black matrix being disposed on a liquid crystal layer side of the counter substrate;
the one or more patterned strain gauge traces being aligned with and in contact with the black matrix on the liquid crystal layer side of the counter substrate.

6. The display device of claim 4, further comprising:
a color filter constituted by color filter layers which are arranged in a cyclic manner;
a black matrix formed in a grid manner so as to partition the color filter layers;
the color filter being disposed on a liquid crystal layer side of the substrate;
the black matrix being disposed on the liquid crystal layer side of the circuit board;
the one or more patterned strain gauge traces being separated from and aligned with the black matrix on opposite sides of the liquid crystal layer.

7. The display device of claim 4, further comprising:
a color filter constituted by color filter layers which are arranged in a cyclic manner;
a black matrix formed in a grid manner so as to partition the color filter layers;
the color filter being disposed on a side of the color filter opposite of a liquid crystal layer side;
the black matrix being disposed on the liquid crystal layer side of the circuit board;
the one or more patterned strain gauge traces being separated from and aligned with the black matrix on opposite sides of the liquid crystal layer.

8. The display device of claim 1, further comprising:
a circuit board;
a substrate disposed so as to face the circuit board;
an organic electroluminescent (EL) layer between the circuit board and the substrate.

9. The display device of claim 8, wherein:
the organic EL layer includes a plurality of sub-pixels;
the plurality of sub-pixels is separated by color separators;
the one or more patterned strain gauge traces being separated from and aligned with the color separators.

10. (canceled)

11. The display device of claim 1, wherein the first strain gauge pattern is a first serpentine pattern along a first direction, and the second strain gauge pattern is a second serpentine pattern along a second direction.

12. The display device of claim 1, wherein at least one of the one or more strain gauge traces is coupled to an excitation source and a sensing circuit.

13. The display device of claim 12, wherein the excitation source is an alternating current (AC) excitation source or a direct current (DC) excitation source.

14. The display device of claim 1, wherein each of the one or more strain gauge traces is coupled to an excitation source, the excitation sources are configured to sequentially provide excitation signals to the corresponding one or more strain gauge traces.

15. The display device of claim 1, wherein each of the one or more strain gauge traces is coupled to an excitation source, the excitation sources are configured to parallelly provide excitation signals to the corresponding one or more strain gauge traces.

16. The display device of claim 1, wherein the one or more strain gauge traces form at least two columns, wherein two of the at least two columns are coupled to differential inputs of a sensing integrated circuit for differential sensing.

17. The display device of claim 1, wherein the touch detection layer comprises a plurality of in-cell touch sensors.

18. The display device of claim 1, wherein:
the plurality of pixels comprises color filter elements;
a light shielding layer is patterned between the plurality of color filter elements;
the one or more patterned strain gauge traces of the strain gauge sensor layer overlap with the light shielding layer.

19. The display device of claim 1, wherein the one or more patterned strain gauge traces comprise conductive material, and are disposed between the plurality of pixels to form a light shielding layer.

20. The display device of claim 1, wherein at least one of the one or more patterned strain gauge traces is connected to a Wheatstone bridge for measuring the one or more touch forces applied to the display device.
